(19) United States
(12) Patent Application Publication
(10) Pub. No.: US 2005/0283258 A1
(43) Pub. Date: Dec. 22, 2005

(54) Method for controlling command sequences, and command control device for carrying out the method

(76) Inventors: Erwin Thalmann, Villach (DE); Sven Boldt, Aschheim (DE)

Correspondence Address: JENKINS, WILSON & TAYLOR, P. A., 3100 TOWER BLVD, SUITE 1400, DURHAM, NC, 27707, US

(21) Appl. No.: 11/153,061

(22) Filed: Jun. 15, 2005

(30) Foreign Application Priority Data
Jun. 22, 2004 (DE) 102004030139.5

(51) Int. Cl. G05B 11/01

(52) U.S. Cl. 700/11; 700/14

(57) ABSTRACT

The invention provides a method for controlling circuit functions of an electronic circuit apparatus, at least one input command signal (201), which is input via an external command bus (205), being buffer-stored in an input buffer (203) of the electronic circuit apparatus, the given input command signal (201) being processed in a processing unit (204) of the electronic circuit apparatus in such a manner that it is possible to control circuit functions of the circuit apparatus, and, before the input command signal (201) is forwarded to the processing unit (204), the input command signal (201) being monitored using a command control device (100) which is connected between the input buffer (203) and the processing unit (204). The invention also relates to an electronic circuit apparatus for carrying out the command monitoring method.

The present invention relates, in general, to electronic circuit apparatuses which can be controlled using input commands that are input via an external command bus, a processing unit of the electronic circuit apparatus processing the input command that has been externally input in order to control circuit functions of the circuit apparatus.

Specifically, the present invention relates to an electronic circuit apparatus having an input buffer for buffer-storing at least one input command signal which is input via an external command bus, and a processing unit for processing the input command signal in such a manner that it is possible to control circuit functions of the electronic circuit apparatus.

Electronic circuit apparatuses (also referred to as electronic chips, electronic components etc.) communicate with other electronic circuit apparatuses via address, data and control buses. Memory chips or memory modules are one known example of an electronic circuit apparatus, the memory cells being selected via the address bus, data being interchanged via the data bus, and finally commands being transmitted via the control or monitoring bus.

Such transmission of different commands causes the electronic circuit apparatus to be changed to precisely defined operating states in such a manner that circuit functions of the circuit apparatus are controlled in a prescribable and precisely specified manner. The transitions between the different operating states are defined, for example, by a state diagram for the electronic circuit apparatus. Transmitting an appropriate command from a current operating state results in a changeover to another permissible operating state.

In this case, conventional electronic circuit apparatuses have the problem that when an impermissible command is transmitted in a current operating state, correct functioning of the electronic circuit apparatus cannot be ensured. An impermissible command is understood to mean the following, for example:
a) a recently transmitted command cannot be executed in a current operating state because no command transition defined in a state diagram is permitted; or
b) a permissible command is executed but at an incorrect point in time (the new command is, for example, transmitted too early).

Problems of this type in conventional electronic circuit apparatuses are serious to the extent that the electronic circuit apparatus can be changed to an undefined state and/or the system is caused to crash.

It is also extremely disadvantageous that subsequent demands which are imposed on an electronic circuit apparatus by an end customer (user), for example, cannot be met if a change of command sequences which is not defined in the original state diagram for the electronic circuit apparatus is requested.

It is also the case that commands which are not defined in the state diagram are not executed or that these commands are executed but a result is written back in an incorrect manner.

Therefore, it is an object of the present invention to provide an electronic circuit apparatus which ensures reliable system operation and which can be adapted to customer-specific demands as regards the command sequences.

According to the invention, this object is achieved by means of an electronic circuit apparatus having the features of patent claim 1.

The object is also achieved by means of a method (specified in patent claim 10) for controlling circuit functions of an electronic circuit apparatus.

Further refinements of the invention emerge from the subclaims.

A fundamental concept of the invention is to connect a command control device between an input buffer for buffer-storing at least one input command signal, which is input via an external command bus, and a processing unit for processing the input command signal, said command control device being designed to monitor the input command signal that has been input via the command bus.

This achieves the advantage that a corrected output command signal which has been output by the command control device 100 has only permissible command sequences, it being possible for command sequences of this type to be subsequently adapted to customer-specific demands.

A command control device of this type which is connected upstream of the processing unit of the electronic circuit apparatus is used for upstream command monitoring such that the command control device is activated only as required in order to internally delay, block or adapt individual critical command sequences. This makes it possible for specific demands which are, for example, subsequently imposed by end users (customers) to be adapted to an existing circuit design.

In this case, the appropriate critical command sequences are stored in corresponding registers and are thus available for individual adaptation. Such adaptation using a test mode is expediently stored in corresponding command monitoring units. This results in the advantage that minor modifications and adaptations can be effected using existing hardware without having to resort to cost-intensive modifications to the circuit design.

A command control device of this type advantageously provides complete command monitoring before a command sequence is input to the processing unit of an electronic circuit apparatus.

The fundamental advantage of a command control device which is connected between an external command bus and a processing unit of an electronic circuit apparatus is increased system reliability with respect to a system crash.

It is also advantageous that functional reliability with respect to impermissible commands which have not been taken into account in the original circuit design of the circuit unit is increased. The circuit arrangement according to the invention thus advantageously provides one possible way of forwarding only permissible commands, and not any possible commands as in the prior art, to the processing unit of the electronic circuit apparatus.

The electronic circuit apparatus essentially has:
a) an input buffer for buffer-storing at least one input command signal which is input via an external command bus; and
b) a processing unit for processing the input command signal in such a manner that it is possible to control circuit functions of the circuit apparatus,
a command control device being connected between the input buffer for buffer-storing the input command signal and the processing unit for processing the input command signal, said command control device being designed to monitor the input command signal that has been input via the command bus.

In addition, the method according to the invention for controlling circuit functions of an electronic circuit apparatus essentially has the following steps of:
a) buffer-storing at least one input command signal, which is input via an external command bus, in an input buffer of the electronic circuit apparatus; and
b) processing the input command signal, which has been input via the external command bus, in a processing unit of the electronic circuit apparatus in such a manner that it is possible to control circuit functions of the electronic circuit apparatus,
in which case, before the input command signal which has been input via the external command bus is processed, the input command signal is monitored using a command control device which is connected between the input buffer for buffer-storing the input command signal and the processing unit for processing the input command signal.

The subclaims contain advantageous developments of, and improvements to, the respective subject matter of the invention.

In accordance with one preferred development of the present invention, the command control device has at least one command monitoring unit for outputting a determination signal on the basis of command monitoring which has been carried out.

In accordance with another preferred development of the present invention, the command control device has at least one comparison unit for comparing the input command signal, which has been input via the external command bus, with a preset signal which has been output by the at least one command monitoring unit.

In accordance with yet another preferred development of the present invention, the command control device has at least one command forwarding unit for forwarding the input command signal, which has been input via the external command bus, to the processing unit on the basis of the determination signal which has been output by the command monitoring unit.

In accordance with yet another preferred development of the present invention, a comparison unit is used to compare the input command signal, which has been input via the external command bus, with the preset signal which has been output by the at least one command monitoring unit.

In accordance with yet another preferred development of the present invention, the at least one command monitoring unit outputs a preset signal on the basis of a time value which is determined in a time value preset unit of the command monitoring unit, the preset signal being compared with the input command signal.

In accordance with yet another preferred development of the present invention, the at least one command monitoring unit outputs a preset signal on the basis of a start condition which is determined in a start condition preset unit of the command monitoring unit, the preset signal being compared with the input command signal.

In accordance with yet another preferred development of the present invention, the at least one command monitoring unit outputs a preset signal on the basis of a waiting time (which is determined in a waiting time preset unit of the command monitoring unit) between an activation command and a read command, the preset signal being compared with the input command signal.

In accordance with yet another preferred development of the present invention, the at least one command monitoring unit outputs a preset signal on the basis of a termination condition which is determined in a termination condition preset unit of the command monitoring unit, the preset signal being compared with the input command signal.

In accordance with yet another preferred development of the present invention, a command forwarding unit is used to forward the input command signal, which has been input via the external command bus, to the processing unit on the basis of the determination signal which has been output by the command monitoring unit.

Exemplary embodiments of the invention are illustrated in the drawings and are explained in more detail in the following description.

In the drawings:

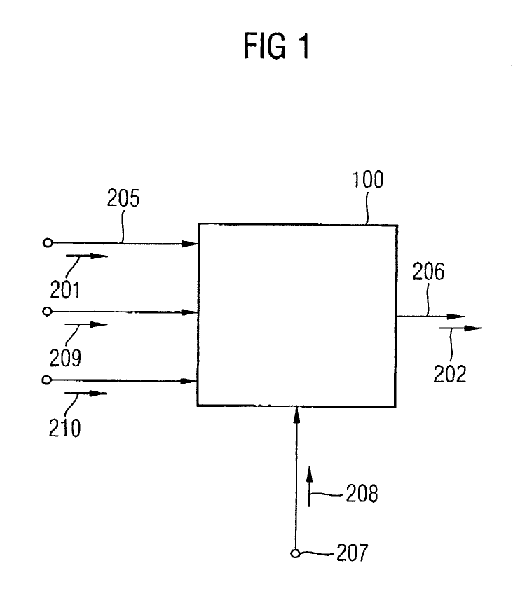

FIG. 1 shows a command control device with input and output signals in accordance with one preferred exemplary embodiment of the present invention; and

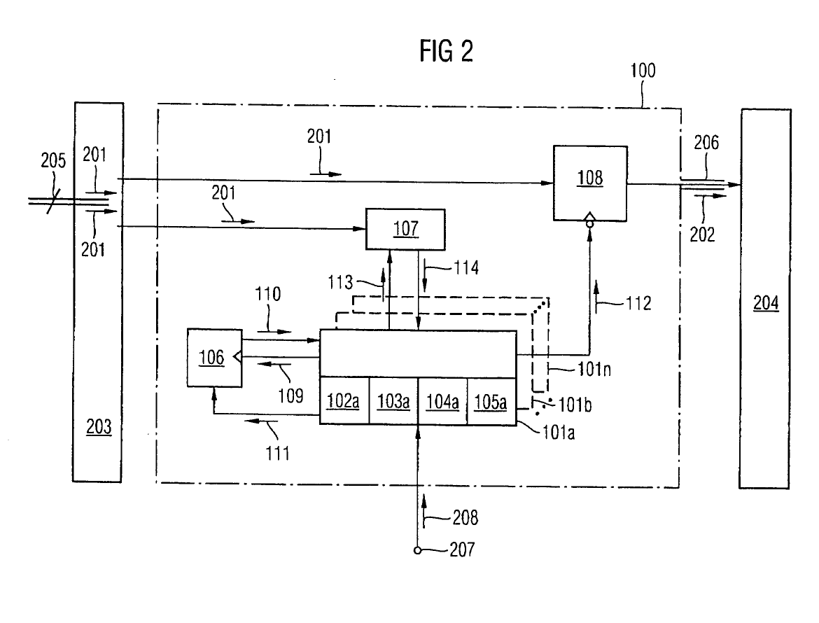

FIG. 2 shows, in greater detail, a block diagram of the command control device shown in FIG. 1 in accordance with one preferred exemplary embodiment of the present invention.

In the figures, identical reference symbols denote identical or functionally identical components or steps.

FIG. 1 shows a block diagram of a command control device 100 with input and output signals. The input command signal 201 (via an external command bus 205), an addressing signal 209 and a clock signal 210 are input to the command control device 100 which, according to the invention, is connected between an input buffer 203 for buffer-storing an input command signal 201 and a processing unit 204 for processing an input command signal 201 (see the description below with reference to FIG. 2). If the electronic circuit apparatus is, for example, a memory module, the memory cells of the memory module are selected via an address bus, and data are interchanged via a data bus. Command sequences are transmitted via a control or monitoring bus.

A test mode signal 208 can also be applied to the command control device 100, said test mode signal being input to the command control device 100 using a test mode input unit 207. A corrected output command signal 202 containing only those command sequences of the input command signal 201 which are permitted in a specific operating state in the electronic circuit apparatus is output from the command control device 100 via an internal command bus 206.

The design and functioning of the command control device 100 will be described in detail below with reference to FIG. 2.

As shown in FIG. 2, the command control apparatus 100 is connected between an input buffer 203 and a processing unit 204 of the electronic circuit apparatus. Command sequences in the form of one or more input command signals 201 are supplied to the electronic circuit apparatus via an external command bus 205. Before the command sequences are processed in the processing unit in order, for example, to control circuit functions of the electronic circuit apparatus, these command sequences of the input command signal 201 are checked, monitored and/or controlled in order to obtain a corrected output command signal 201 which is passed to the processing unit 204 via an internal command bus 206.

In this case, one fundamental component of the command control device 100 is illustrated using a block 108 which represents a command forwarding unit. The input command signal 201, on the one hand, and a determination signal 112, on the other hand, are supplied to the command forwarding unit 108. The determination signal 112 is output by a command monitoring unit 101a-101n in the command control device 100 on the basis of command monitoring which has been carried out.

It should be pointed out that the command control device 100 can have one or more command monitoring units 101a-101n although the following description relates to only one command monitoring unit 101a. If the determination signal 112 indicates, for example, that the input command signal 201 contains a permissible command or a permissible command sequence, the command forwarding unit 108 forwards this command sequence from the input buffer 203 to the processing unit 204 via the internal command bus 206. If an impermissible command is detected, or a command is detected at an impermissible point in time, in the at least one command monitoring unit 101a-101n, the determination signal 112 is modified in such a manner that driving the command forwarding unit 108 using the determination signal 112 results in the input command signal which has been supplied by the input buffer 203 being blocked by the command forwarding unit 108.

According to the invention, this achieves the advantage that impermissible commands are prevented from being supplied to the processing unit 204 in such a manner that problems in the electronic circuit unit, for example the risk of a system crash, are eliminated.

The text below explains how the command control device 100 determines whether a permissible or an impermissible input command signal 201 is output from the input buffer 203. A preset signal 113 which is essential to the assessment of whether a permissible or an impermissible command sequence is present is generated in the command control device 101a on the basis of specific criteria which can be set in the blocks 102a, 103a, 104a and 105a (described below).

The preset signal 113 is compared, in a comparison unit 107 which is provided in the command control device 100, with the input command signal 201 which is supplied to both the command forwarding unit 108 and the comparison unit 107. If a comparison result signal 114 which has been output from the comparison unit 107 indicates that the input command signal 201 matches the preset signal 113 as regards specific criteria (described below), the command monitoring unit 101a outputs the determination signal 112 to the command forwarding unit 108 on the basis of this comparison result signal 114 such that the input command signal 201 which has been input via the external command bus 205 is forwarded to the processing unit 204.

The command control device 100 also has a timer 106 which is driven using a start signal 109 that is provided by the command monitoring unit 101a. The timer 106 outputs a reset signal 110 when the command monitoring unit 101a is to be reset in accordance with a prescribable criterion. The timer 106 receives a time reference signal 111 from a time value preset unit 102a that is provided in the command monitoring unit 101a.

The command monitoring units 101a-101n which are provided in the command control device 100 each have a time value preset unit 102a-102n, a start condition preset unit 103a-103n, a waiting time preset unit 104a-104n and a termination condition preset unit 105a-105n. The at least one command monitoring unit 101a-101n outputs a preset signal 113 on the basis of a time value which is determined by the time value preset unit 103a-103n of the command monitoring unit 101a-101n, the preset signal 113 being compared with the input command signal 201. The at least one command monitoring unit 101a-101n also outputs a preset signal 113 on the basis of a start condition which is determined by a start condition preset unit 103a-103n of the command monitoring unit 101a-10n, the preset signal 113 being compared with the input command signal 201.

The at least one command monitoring unit 101a-10n also outputs a preset signal 113 on the basis of a waiting time (which is determined by a waiting time preset unit 104a-104n of the command monitoring unit 101a-10n) between an activation command and a read command, the preset signal 113 being compared with the input command signal 201.

A current command signal 201 which has been input via the external command bus 205 is respectively compared, in the comparison unit 107, with a first command in a command sequence that is stored in the command monitoring unit 101a-101n. A comparison of the current command signal with a second command is then started. In the event of a match with the first command, the time value preset unit 102a-102n also loads a time value (which is possibly stored) into the timer 106, and the timer 106 is started.

It should be pointed out that it is also possible for no time value to be stored, with the result that the stored second command is waited for without any time restriction. It is thus possible to detect command sequences of the input command signal 201 independently of timing.

Resetting is effected either when the timer 106 has timed out, that is to say when the timer 106 outputs the reset signal 110 without the second command appearing on the external command bus 205 or in the input buffer 203, or a match with a termination command (termination condition) which is provided by the termination condition preset unit 105a-105n.

In the abovementioned cases, the command monitoring unit 101a-101n is reset, and the first command in the command sequence of the input command signal 201 is loaded again as a reference. As long as no critical command sequence is detected, all of the input commands 201 which have been input via the external command bus 205 are switched through directly to the internal command bus 206 using the command forwarding unit 108 and are output in the form of a corrected output command signal 202.

Different measures may be taken in the event of a detected critical command sequence (for example an impermissible command):
(i) instead of the command which was originally transmitted, another command is forwarded; a command should, for example, be ignored; a command which was originally sent is blocked, a “blank command” being transmitted on the internal command bus 206 instead; or
(ii) the command which was originally transmitted is forwarded to the internal command bus 205 with a time delay; this makes it possible to separate (release) temporally critical command sequences, it being possible, under certain circumstances, to avoid cost-intensive redesign of the electronic circuit apparatus.

The command control device 100 according to the invention, as a circuit extension for an electronic circuit apparatus, the circuit extension being arranged between an input buffer 203 and a processing unit 204 of the electronic circuit apparatus, advantageously makes it possible to ensure that the command sequence or the temporal sequence of individual commands or individual command sequences can be blocked and not forwarded or can be changed or modified. This makes it possible to ensure reliable operation of the electronic circuit apparatus, for example a memory module (DRAM, Dynamic Random Access Memory) given a wide variety of specifications. A plurality of different command sequences may also be advantageously stored and thus modified in a parallel manner.

It should be pointed out that the command control apparatus 100 shown in FIG. 2 may also be designed to be bidirectional, that is to say the command control device 100 is used to check command sequences bidirectionally in such a manner that the reliability of a command (in the command sequence 201) which is to be input to the processing unit 204 of the electronic circuit apparatus via the external command bus 205 or is to be output from said processing unit is checked using the command monitoring unit 101a-101n which is provided in the command control device 100. The command control device according to the invention provides extensive command monitoring which advantageously increases system reliability and avoids system crashes. Subcomponents such as a processor unit, a controller unit and memory units can thus be manufactured by different manufacturers which do not necessarily have to use a standard protocol. If impermissible command sequences are transmitted, the overall system nevertheless does not fail on account of the upstream command control device 100.

It is also advantageous that the command sequences of the input command signal 201 can subsequently be adapted to customer-specific demands.

Although the present invention has been described above with reference to preferred exemplary embodiments, it is not restricted thereto but rather can be modified in a variety of ways.

The invention is not restricted to the application possibilities mentioned either.

1. Electronic circuit apparatus having:
a) an input buffer for buffer-storing at least one input command signal which is input via an external command bus; and
b) a processing unit for processing the input command signal in such a manner that it is possible to control circuit functions of the electronic circuit apparatus, wherein
c) a command control device is connected between the input buffer for buffer-storing the input command signal and the processing unit for processing the input command signal, said command control device being designed to monitor the input command signal that has been input via the command bus.

2. Apparatus according to claim 1, wherein the command control device has at least one command monitoring unit for outputting a determination signal on the basis of command monitoring which has been carried out.

3. Apparatus according to claim 2, wherein the command control device has at least one comparison unit for comparing the input command signal, which has been input via the external command bus, with a preset signal which has been output by the at least one command monitoring unit.

4. Apparatus according to claim 2, wherein the command control device has at least one command forwarding unit for forwarding the input command signal, which has been input via the external command bus, to the processing unit on the basis of the determination signal which has been output by the command monitoring unit.

5. Apparatus according to claim 2, wherein the at least one command monitoring unit has a time value preset unit for generating a preset signal on the basis of a time value which is determined in the command monitoring unit.

6. Apparatus according to claim 2, wherein the at least one command monitoring unit has a start condition preset unit for generating a preset signal on the basis of a start condition which is determined in the command monitoring unit.

7. Apparatus according to claim 2, wherein the at least one command monitoring unit has a waiting time preset unit for generating a preset signal on the basis of a waiting time (which is determined in the command monitoring unit between an activation command and a read command.

8. Apparatus according to claim 2, wherein the at least one command monitoring unit has a termination condition preset unit) for generating a preset signal on the basis of a termination condition which is determined the command monitoring unit.

9. Apparatus according to claim 3, wherein a comparison unit is used to compare the input command signal which has been input via the external command bus, with the preset signal which has been output by the at least one command monitoring unit.

10. Method for controlling circuit functions of an electronic circuit apparatus, said method having the steps of:
a) buffer-storing at least one input command signal, which is input via an external command bus, in an input buffer of the electronic circuit apparatus; and
b) processing the input command signal, which has been input via the external command bus, in a processing unit of the electronic circuit apparatus in such a manner that it is possible to control circuit functions of the electronic circuit apparatus, characterized in that the following step is carried out before step b):
a1) monitoring the input command signal which has been input via the external command bus using a command control device which is connected between the input buffer for buffer-storing the input command signal and the processing unit for processing the input command signal.

11. Method according to claim 10, wherein at least one command monitoring unit which is arranged in the command control device is used to generate a determination signal on the basis of command monitoring which has been carried out.

12. Method according to claim 11, wherein the at least one command monitoring unit outputs a preset signal on the basis of a time value which is determined in a time value preset unit of the command monitoring unit, the preset signal being compared with the input command signal.

13. Method according to claim 11, wherein the at least one command monitoring unit outputs a preset signal on the basis of a start condition which is determined in a start condition preset unit of the command monitoring unit, the preset signal being compared with the input command signal.

14. Method according to claim 11, wherein the at least one command monitoring unit outputs a preset signal on the basis of a waiting time (which is determined in a waiting time preset unit of the command monitoring unit between an activation command and a read command, the preset signal being compared with the input command signal.

15. Method according to claim 11, wherein the at least one command monitoring unit outputs a preset signal on the basis of a termination condition which is determined in a termination condition preset unit of the command monitoring unit, the preset signal being compared with the input command signal.

16. Method according to claim 12, wherein a comparison unit is used to compare the input command signal, which has been input via the external command bus, with the preset signal which has been output by the at least one command monitoring unit.

17. Method according to claim 11, wherein a command forwarding unit is used to forward the input command signal, which has been input via the external command bus, to the processing unit on the basis of the determination signal which has been output by the command monitoring unit.
